(19) United States
(12) Patent Application Publication
(10) Pub. No.: US 2015/0012285 A1
(43) Pub. Date: Jan. 8, 2015

(54) SYSTEM AND METHOD FOR IMPROVING PHARMACY CLAIM PAYMENT CAPABILITIES

(71) Applicant: CIGNA INTELLECTUAL PROPERTY, INC., Wilmington, DE (US)

(72) Inventors: Thom STAMBAUGH, Unionville, CT (US); Jon Maesner, Farmington, CT (US); Diana Kycia, West Hartford, CT (US); Dean McClain, Phoenixville, PA (US); Kevin Herzig, Windsor, PA (US)

(73) Assignee: CIGNA INTELLECTUAL PROPERTY, INC., Wilmington, DE (US)

(21) Appl. No.: 14/281,441

(22) Filed: May 19, 2014

Related U.S. Application Data
(60) Provisional application No. 61/824,592, filed on May 17, 2013.

(51) Int. Cl. G06F 19/00

(52) U.S. Cl. CPC G06F 19/328
USPC 705/2

(57) ABSTRACT

The present invention provides improved systems and methods for enhancing pharmacy claim payment capabilities. In one example aspect the invention provides a method for determining whether to process a claim for a drug for a member, comprising the steps of receiving the claim for the drug subject to specific clinical edits, accessing criteria specific to the drug, evaluating the claim for the drug with regard to the criteria specific to the drug, and determining based on one or more of the criteria whether to process the claim.

### CROSS REFERENCE TO RELATED APPLICATION

This application claims the benefit of U.S. Provisional Application No. 61/824,592, filed May 17, 2013, the entire contents of which are hereby incorporated by reference, as if fully contained herein.

### BACKGROUND OF THE INVENTION

1. Field of the Invention

The present invention generally relates to a method, system, apparatus, and program for enhancing pharmacy claim payment capabilities.

2. Related Art

The changing landscape of the healthcare industry has brought a number of challenges. Federal reform requires payers to (1) expand member care by, e.g., eliminating limitations to pre-existing conditions, (2) add minimum benefits, and (3) include coverage for the uninsured. As a result, executives of health plans are under increased pressure to better manage costs while improving access to care, as various parties, including government entities, members, employer groups, and regulators, simultaneously demand more affordable premiums.

Given the above situation, there exists a need for novel solutions for controlling cost and facilitating claim payments.

### SUMMARY OF THE INVENTION

The foregoing and other problems are ameliorated or overcome by an improved method for enhancing the pharmacy claims payment process, and also by a system, apparatus, and program that operate in accordance with the method.

One of the major issues with respect to claims payment for drugs is when clinical edits stop a claim from processing for the purpose of a medical necessity review. Currently, drugs using these clinical edits require an authorization be created in the claim system for the claim to pay. Lack of an authorization will result in a rejection of the claim. In order to process the claim, the prescriber is required to contact the plan to provide clinical information to support the medical necessity review process. According to industry research, the vast majority of authorizations require a phone call or a faxed request. Routine authorizations can take days or weeks to resolve. Costs are incurred by both prescribers and healthplans to administer the authorization process. Moreover, physicians often have trouble determining which tests, procedures, and drugs require authorizations.

The present invention in one aspect provides a solution by leveraging data access and creating/implementing a set of rules with respect to a specific drug to allow a claim submitted for specific drugs that meet certain criteria to automatically pay. This can reduce the impact on the member at the Point of Service.

In more detail, the present invention results in a system or method that can, inter alia, (1) waive authorization requirements for targeted physicians who prescribe targeted drugs that trigger targeted clinical edits, and (2) provide auto pay capabilities based on rules maintained by, e.g., a health care management company or a health insurance/services company, through a call out service. Accordingly, based on certain processing rules, an automated “Service Call” to the health care management company can allow receipt of edit data, the incorporation of medical facts into the claim payment process, and communication to, e.g., an independent provider of health care information management services, to pay a claim without having an authorization in place.

Accordingly, the present invention can enhance pharmacy claim payment capabilities to (1) leverage medical facts, clinical information, and technology to automate payment of pharmacy claims subject to coverage review and provide members with immediate access to medications, and (2) use established health care professional quality and efficiency information to facilitate a member's access to medications.

The present invention can be particularly useful to a PBM (Pharmacy Benefit Manager) integrated into a medical payer. Such an entity has the ability to leverage medical information (e.g., diagnosis, lab results, physician network status) into the pharmacy claims payment process. Standalone PBMs are not able to do so given their limited access to medical data. The integration of the physician network status can link the medical and pharmacy benefits together and leverage the pharmacy benefit to support future strategic activity (value-based pharmacy plan design) that will provide an incentive to members to access affordable and quality care under their medical plan.

Beyond this immediate integration point, the present invention can expand health advocacy messaging (i.e., gaps in member care, availability of programs and services, reminders that lab tests are due, etc.) to contracted pharmacies, and advance the health care, well being, and security of members.

When the integration of medical facts does not result in payment of the pharmacy claim, there may be a proactive outreach to the physician to request the specific facts that are not available to the health care management company (e.g., the PBM integrated into a medical payer). As data sources become enriched, the present invention results in a system which no longer requires prior authorization from physicians prospectively but instead will contact physicians only as needed. This in effect transforms the space from a “Mother may I” to a “Don't call us; we'll call you” approach to the traditional clinical review process. In this system, physicians are not asked to provide member information to support a clinical review when such information is already available.

By virtue of the features of the present invention, members can have immediate access to medications that may have been previously delayed because a clinical review was required. Physicians can realize a decrease in administrative processes required when their patients utilize the system and method of the present invention.

The invention according to one aspect provides a method implemented on a computer having a processor and a memory coupled to the processor for determining whether to process a claim for a drug for a member. The method comprises the steps of: receiving the claim for the drug subject to specific clinical edits, accessing criteria specific to the drug, evaluating the claim for the drug with regard to the criteria specific to the drug, and determining based on one or more of the criteria whether to process the claim. At least one of the steps is performed using the processor. The criteria includes at least one of: a) sex of the member, b) age range of the member, c) a dosage range of the drug, d) existence of a prior claim within a predetermined time period with (i) one or more instances of another drug used in a given list, or (ii) one or more instances of a past diagnosis in a given list, or (iii) one or more instances of a past procedure in a given list, and e) existence of one or more lab results for a given condition.

The invention according to another aspect provides a method implemented on a computer having a processor and a memory coupled to the processor for creating a claim evaluation system for determining whether to process a claim for a drug for a member, comprising the steps of creating a set of rules criteria, storing the set of rules criteria in a database, accessing medical data to construct a set of data to be used in evaluating the claim, and evaluating the claim based on the set of rules criteria to determine whether to process the claim.

The invention according to another aspect provides a method implemented on a computer having a processor and a memory coupled to the processor for determining whether to process a claim for a drug for a member. The method comprises the steps of receiving the claim for the drug, evaluating whether the claim meets predetermined clinical edits, and if the claim meets the predetermined clinical edits, processing the claim. If the claim does not meet the predetermined clinical edits, evaluating whether the claim meets a set of criteria including at least one of certain drugs, certain physicians, and certain associated edits of drugs. If the claim meets said set of criteria, processing the claim; if the claim does not meet said set of criteria, processing the claim if a pre-authorization exists or if the drug is available for AutoPay, otherwise denying the claim. At least some of the steps are performed by the processor.

The invention according to another aspect provides a method implemented on a computer having a processor and a memory coupled to the processor for determining whether to process a claim for a drug for a customer. The method comprises the steps of receiving, by a claim engine, a claim for a drug for a customer, and evaluating, by the claim engine, the claim for the drug and obtaining an initial decision whether to pay the claim. If the initial decision is to pay the claim, authorizing payment of the claim; if the initial decision is to deny the claim due to an edit code on a drug edit list, then: calling an authorization service module; reading, by the authorization service module, the claim and sending the claim to a rules engine; searching by the rules engine whether there are customer facts in a customer facts database and if so then loading by a rules module a set of rules and sending the customer conditions as well as point of sale variables to be evaluated by the rules; receiving an answer, based on the rules evaluation, as to whether an authorization waiver override should be issued; sending the answer to the authorization service module; encoding by the authorization service module the answer and sending the answer back to the claim engine; checking, by the claim engine, for the existence of the authorization waiver override inside the answer; and if the authorization waiver override was issued, allowing, by the claim engine, the claim to pay.

The invention according to another aspect provides a system for determining whether to process a claim for a drug for a member, comprising a data integration unit, adapted to receive the claim for the drug subject to specific clinical edits; a rules unit, adapted to access criteria specific to the drug and evaluate the claim for the drug with regard to the criteria specific to the drug; and an authorization unit, adapted to determine based on one or more of the criteria whether to process the claim.

The invention according to another aspect provides a system for determining whether to process a claim for a drug for a member, comprising: a data integration unit, adapted to receive the claim for the drug; a rules unit, adapted to evaluate whether the claim meets predetermined clinical edits, and if the claim does not meet the predetermined clinical edits, evaluate whether the claim meets a set of criteria including at least one of certain drugs, certain physicians, and certain associated edits of drugs; and an authorization unit, adapted to authorize processing of the claim if the claim meets the predetermined clinical edits or if the claim meets the set of criteria; and if the claim does not meet said set of criteria, authorize processing of the claim if a pre-authorization exists or if the drug is available for AutoPay, otherwise deny the claim.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will be more readily understood from a detailed description of the exemplary embodiments taken in conjunction with the following figures:

FIG. 1 is a flowchart illustrating a pharmacy claim payment method according to an aspect of the present invention.

FIG. 2 is also a flowchart illustrating a pharmacy claim payment method according to another aspect of the present invention.

FIG. 3 is a diagram illustrating a pharmacy claim payment system according to one aspect of the present invention.

FIGS. 4, 5, and 6A-6C illustrate example processes for three decision trees, relating to the drugs Revatio and Adcirca, and the condition ED (erectile dysfunction), respectively.

FIG. 7 illustrates a concurrent Drug Utilization Review (cDUR) process according to another aspect of the present invention.

FIG. 8 shows current requirement for the cDUR logic of the aspect of the present invention shown in FIG. 7, according to an example aspect of conditions and drug classes that cDUR will operate on.

The invention will next be described in connection with certain exemplary embodiments; however, it should be clear to those skilled in the art that various modifications, additions, and subtractions can be made without departing from the spirit or scope of the claims.

### DETAILED DESCRIPTION OF THE PREFERRED EMBODIMENTS

An example embodiment of the invention provides an improved method for enhancing pharmacy claim payment capabilities, and also a system, apparatus, and program that operate in accordance with the method.

Plans have the ability to apply clinical “edits” to drugs that will deny a claim. To override that edit requires pre-authorization by the plan before the claim is paid by the plan. Once the plan approves the drug for a member, the plan enters an authorization into the system to override the applicable edits. If the member has an active authorization in place for that drug and associated edits, the system will use the authorization to pay the claim. If an active authorization does not exist, the claim will continue to process and will return applicable error messages to the pharmacy POS indicating why the claim did not pay.

There are prescribers who practice in a specialty that often prescribe drugs that require authorization. Often, drugs prescribed by providers in these specialties meet the criteria to receive an authorization from the plan. Plans have the opportunity to utilize programming to override certain edits for drugs prescribed by these specialists, eliminating the need for the prescriber and/or member to obtain an authorization from the plan. The present invention in one aspect utilizes programming for specific drugs subject to specific edits to be overridden based on the specialty of the prescriber.

Example criteria to call the PCE (Pharmacy Claim Enhancement) Service according to the present invention is as follows. Suppose in the claims process a claim comes through for a specific drug that is subject to specific clinical edits by the health care management company. Example criteria used by the health care management company to evaluate the request may include, inter alia: (1) whether the member is male or female; (2) whether the member's age is within a given range; (3) whether the dosage of the drug is within a given range; (4) whether a prior claim exists within the past X number of days with (i) one or more instances of a prior drug used in a given list, (ii) one or more instances of a past diagnosis in a given list, or (iii) one or more instances of a past procedure in a given list; and (5) whether one or more lab results exist for a given condition.

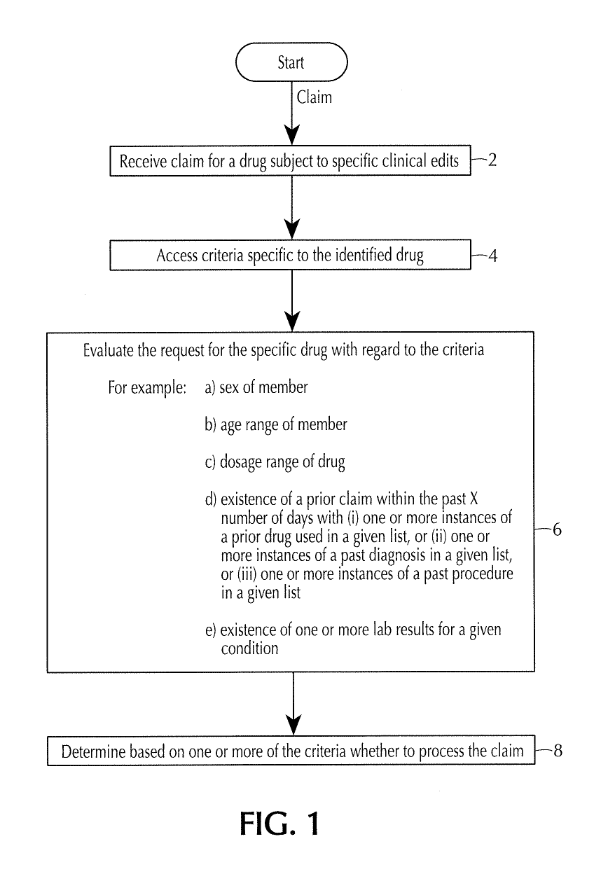

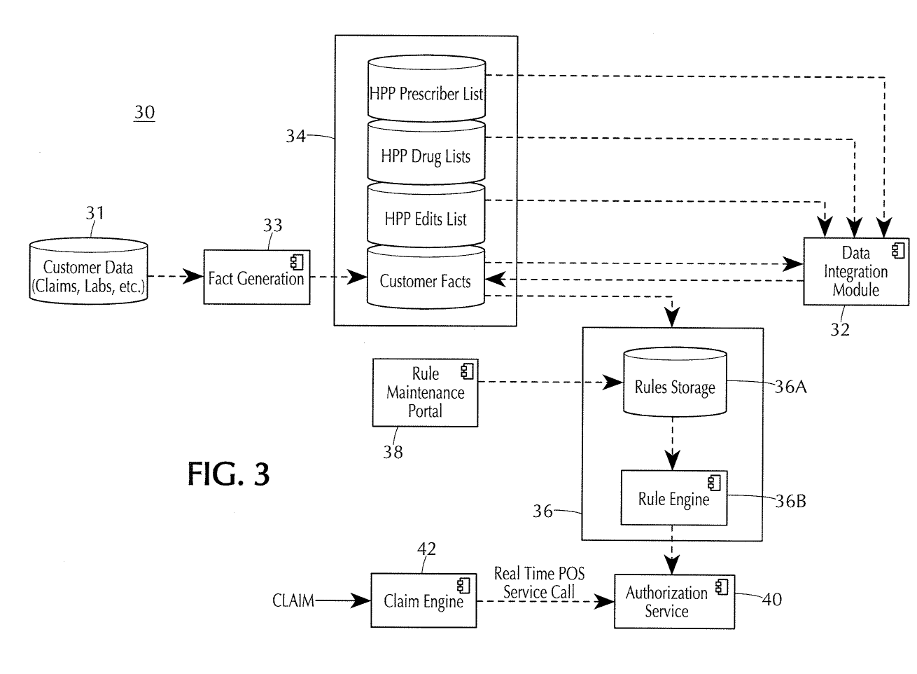

See FIG. 1, which is a flowchart illustrating a pharmacy claim payment method according to one aspect of the present invention. The method can be implemented by a computer or by software or software modules programmed to carry out the steps of the method, such as the system 30 of FIG. 3. The software modules can access various databases of information which may reside inside or outside the system.

In this example aspect of criteria to call the PCE service, the method utilizes criteria specific to a specific drug that is on a list that is supplied by, e.g., a health care management company, to determine whether a claim is to be processed. The criteria are consistent with the published coverage policy specific to each drug as established by the plan. That is, different criteria apply to different drugs, and as such different “rules” and conditions govern the determination whether the claim is to be processed. The rules are designed using an algorithmic model and accesses copious data to make the determination as to a particular claim. The data can be stored in databases which may be, e.g., at the site of a health care management company, at an off site such as the site of an independent provider of health care information services, in a cloud, etc.

In step 2 of FIG. 1, a claim is received for a drug (e.g., by claim engine 42 of FIG. 3) subject to specific clinical edits. The drug may be, for example, a drug for treating arthritis. In step 4, different criteria is accessed (e.g., by rules module 36 of FIG. 3) which is specific to the identified drug.

In step 6, the request is evaluated (e.g., by the rules module 36 of FIG. 3) with regard to the criteria as established in the coverage policy. This can occur in two ways: a model can be utilized that scans through the data (stored, e.g., in database 34 of FIG. 3) using an algorithm; or a rules engine can be utilized which uses data (stored, e.g., in database 34 of FIG. 3) from members who are identified as having specific conditions, and the data is inputted into the rules engine.

Example criteria may include, but is not limited to:
a) sex of member (member is male or female);
b) age range of member (age is within a given range);
c) dosage range of drug (dosage is within a given range);
d) existence of a prior claim within the past X number of days with (i) one or more instances of a prior drug used in a given list, (ii) or one or more instances of a past diagnosis in a given list, or (iii) one or more instances of a past procedure in a given list; e) existence of one or more lab results for a given condition.

In step 8, it is determined (by, e.g., the rules module 36 of FIG. 3) based on the criteria (one or more of the criteria in a preferred embodiment) as applied to the data whether to process the claim. If insufficient information exists to pay the claim, the claim is rejected.

The clinical edit descriptions included in one aspect of the present invention may include but are not limited to: prior authorization required; exceeds adult maximum dosage guidelines; exceeds therapy allowed at this dose; prior drug therapy required by plan; previous therapy excludes this drug; exceeds quantity therapy allowed; submitted drug is excluded because of age; submitted drug is excluded because of sex; ingredient or total cost greater than allowed by plan; quantity greater than allowed by plan; exceeds geriatric maximum dosage guidelines; exceeds pediatric minimum dosage guidelines; submitted drug is inappropriate for gender of patient; submitted drug is inappropriate for sex of patient; etc.

Accordingly, the methods and systems disclosed herein can (1) create, maintain, and edit a set of rules or rules criteria as part of a claim evaluation system, (2) scan/access medical data to construct a set of data for processing or evaluating a claim based on the rules criteria, and (3) process or evaluate a claim based on the applicable rules criteria. The medical data can be scanned using previous diagnoses, using data specific to patients/drugs/physicians, using a data source comprising previous pharmacy claims, etc. The claim evaluation process can then for example set a series of flags for data fields of the data/criteria to YES or NO based on the rules criteria, resulting in a processing or rejection of the claim.

The medical data can include, for example, (a) lab values from diagnostic vendors such as Quest Labs (blood sugar, other abnormal lab values), (b) pharmacy claims from a Pharmacy claim vendor (diagnosis and prior drug use), (c) medical claims from Claim engines of e.g. a health care management company (diagnosis and prior drug use), (d) demographic data passed from the claim vendor during a point of sale transaction, or from an eligibility data source from the health care management company (age, sex), etc.

There can be multiple sources for claims and for lab values. Those may start in different formats and get loaded into the system's databases or data warehouse where they are normalized into one format for lab and one for claims. From there the process transforms the data into facts which may not necessarily resemble the data warehouse structures. Then, the system may consume those facts into an in-memory database that is engineered for extremely fast throughput (and transformed again) to be used in the system's rules engine. A traditional database on disk may also be employed but typically takes longer to read.

The system has a data model or interface for getting each of the lab values, pharmacy claims, medical claims, and demographic data, etc. The data elements available for each data source (fields) of pharmacy claim data may be, for example:
1. Member ID
2. Diagnosis code
3. CPT Code
4. Rx date
5. Drug
6. Prior Use Drug
7. Lab Results
8. Dosage Range
9. Quantity/volume

By virtue of the features of the invention, medical information can be leveraged into the pharmacy claims process and, when all criteria are met, claims will pay without the need to create an authorization. Physician network status and medical facts can be integrated to link medical and pharmacy benefits together to support future activity.

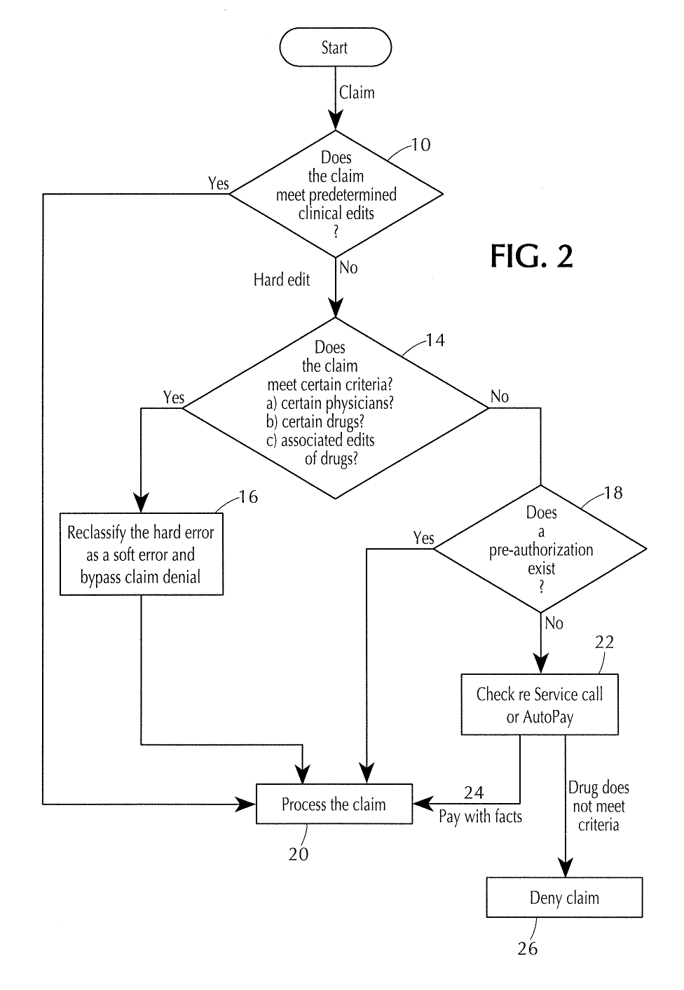

FIG. 2 is also a flowchart illustrating a pharmacy claim payment method according to another aspect of the present invention. The method can be implemented by a computer or by software or software modules programmed to carry out the steps of the method, such as the system 30 of FIG. 3. The software modules can access various databases of information which may reside inside or outside the system.

During traditional claims processing, if a claim does not meet certain clinical edits, it is assigned a “hard edit,” which is an error code that is set to deny payment of the claim unless later reclassified as a soft error. The new process according to the present invention will instead determine if the claim meets certain criteria to bypass denial of the claim.

In step 10 of FIG. 2, a claim is received and it is ascertained (e.g., by the data integration module 32 of FIG. 3) whether the claim meets one or more predetermined clinical edits. If so (“YES”), the claim is processed (step 20). If not (“hard edit”), the method proceeds to step 14 where the process will begin to determine step by step whether the claim meets certain criteria.

Specifically, in step 14 it is ascertained (by, e.g., the data integration module 32 of FIG. 3) whether a) the physician is on a High Performance Pass or “HPP” Prescriber List, b) the drug is identified in an HPP Drug List, and c) associated edits of the drugs are identified in an HPP Edits List. The aforementioned HPP Lists may be located in one or more databases maintained inside or outside the system (such as database 34 of FIG. 3). It is of course to be understood that these are merely examples and the invention is not limited thereto. Other example criteria could include those listed in step 6 of FIG. 1.

In more detail, certain physicians are High Performance Pass (HPP) prescribers and participate in the program. Claims attributed to active HPP prescribers for identified drugs and their targeted edits (error codes) will bypass the pre-authorization process entirely. The HPP Prescriber List and the associated lists (i.e., the HPP Drug Lists, and the HPP Edits Lists) may be provided and maintained by, e.g., the health care management company, either inside or outside its environment (e.g., in a cloud, or at the site of an independent provider of health care services, etc.).

If it is determined in step 14 that all the criteria a), b), and c) are met (“YES”), the hard error is reclassified as a soft error and claim denial is bypassed (step 16), after which the method proceeds to step 20 and the claim is processed for payment. Thus, when an authorized HPP prescriber prescribes a drug and the drug with its associated HPP edit (error code) is found for that prescriber, the hard error is reclassified as a soft error and the claim with Pay with Waiver.

If, however, it is determined in step 14 that one or more of the criteria a), b), and c) are not met (“NO”), or that a hard edit still exists, the method proceeds to step 18 which checks whether an authorization exists. Thus, when HPP edits are not met, (e.g., the prescriber is not on the HPP list, or the drug does not meet the criteria), or other hard edits still exist on the claim, the method will check to see if an existing authorization exists.

If an authorization exists and all hard errors are classified as soft errors (“YES”), the method proceeds to step 20 and the claim is paid.

If it does not meet this test, it may be a candidate for an automated “Service Call” (a.k.a. “AutoPay”)—step 22. If the drug is not a candidate for AutoPay, it continues through claims processing.

An AutoPay call to the health care management company allows identified drugs that meet processing rules specified by the health care management company to override clinical edit requirements when the criteria in these processing rules are met. Certain claim information is sent (e.g., from the independent provider of health care information services) to the health care management company. If the prescribed use of the drug meets the criteria, the health care management company sends a message back to the provider (Claims Payer) to bypass the associated error code and its associated message. When the provider receives a message such as “Pay with Facts,” the associated error code is reclassified as a soft error (step 24) and claim denial is bypassed such that the claim is processed (step 20). If the claim does not meet or find the required facts, the health care management company sends a message back to the provider, and the claim maintains the associated hard error code and its associated error message, and the claim is rejected (step 26).

Each HPP prescriber can have distinct lists of drugs and associated edits for which the edit is waived. A cross-reference file is created and stored which associates a prescriber to a specific set of drugs (Drug List). An HPP prescriber can be associated with more than one Drug List. Records include the Prescriber ID, the Drug List name, Begin Date, and End Date. This file will be used in HPP processing to connect a prescriber with the appropriate Drug List(s) to determine if the drug on the claim is eligible for HPP processing. Drug List tables can be populated and maintained using the standard Mass Load Process. Tables can be shared. (Example: Physician A uses Drug List A, Physician B uses Drug List B, and Physician C uses Drug List A and Drug List B.) The lists may be periodically updated. (Steps 14-18 and 22 of FIG. 2 may be performed by, e.g., the rules module 36 of FIG. 3.)

According to an aspect of the invention, when a claim has a combination of hard error codes (edits), of which only some are eligible to be waived, the HPP process will be bypassed; no errors associated with the HPP process will be reclassified to soft error status. When a claim has a combination of hard error codes (edits), of which only some are eligible to be waived, the Autopay process will be bypassed; no errors associated with the Autopay process will be reclassified to soft error status.

Other criteria can also be relevant to the process, such as whether the claim, HPP prescriber, or drug is on a “first fill.”

FIG. 3 is a diagram illustrating a pharmacy claim payment system 30 according to one aspect of the present invention. The system 30 can implement the methods of the present invention disclosed herein including those of FIGS. 1 and 2 using a computer, software, or software modules programmed to carry out the steps of the method(s). The software modules can access various databases of information which may reside inside or outside the system 30.

The system 30 includes a data integration module or unit 32 which has access to a database 34 which maintains customer facts and various lists, e.g., drug lists, prescriber lists, edits lists, physicians lists, lists with for example the data for the example criteria mentioned in step 6 of FIG. 1 or step 14 of FIG. 2, etc. These lists can be created, updated, and revised as needed. The data integration module 32 receives customer facts (e.g., step 2 of FIG. 1) and makes the data available to a rules module or unit 36. The customer facts are generated at least in part by the fact generation module 33 to which is fed customer data (claims, labs, etc.) from the database 31, and the customer facts are stored in the customer facts portion of the database 34. The rules module or unit 36 contains a rules storage database 36A (which stores rules that can be maintained by, e.g., the rules maintenance portal 38) and a rules engine 36B.

The claim engine 42 waits for, e.g., a customer point of sale purchase of a drug (e.g., step 2 of FIG. 1 or step 10 of FIG. 2). Once the claim engine 42 receives a claim for a drug, it evaluates the claim according to its own internal logic. If the claim is going to be denied and the reason for denial is one of the edit codes on the drug edit list contained in the database 34, and the drug is one of the drugs listed in the drug edit list, then the claim engine 42 will call the authorization service 40. The authorization service 40 reads the request and sends it on to the rules engine 36B. The rules engine 36B searches to see if the customer has facts in the customer fact database (of database 34). If so, then the rules module 36 will load the appropriate set of rules and send the customer conditions as well as point of sale variables to be evaluated by the rules. The rules will return an answer as to whether an authorization waiver should be issued. The answer, negative or positive, is then sent back to the service module or authorization service 40. The service module 40 then encodes the answer and sends it back to the claim engine 42. The claim engine 42 checks for the existence of a waiver override inside of the message it received. If an authorization waiver was issued, the claim engine 42 then turns the specific hard edits into soft edits, allowing the claim to pay. The response is then sent back to the pharmacy.

By virtue of the features of the invention, medical information can be leveraged into the pharmacy claims process and exceptions to pre-authorization can be implemented. Physician network status and medical facts can be integrated to link medical and pharmacy benefits together to support future activity.

Accordingly, the present invention provides innovative pharmacy claim payment and Rx (prescription) value innovator privileges for HPP or qualifying physician groups. It is noted that it is not necessary to use all of the example criteria listed above for each drug. Further, the system 30 via, e.g., its rules portal 38 can enable manual writing of the rules criteria.

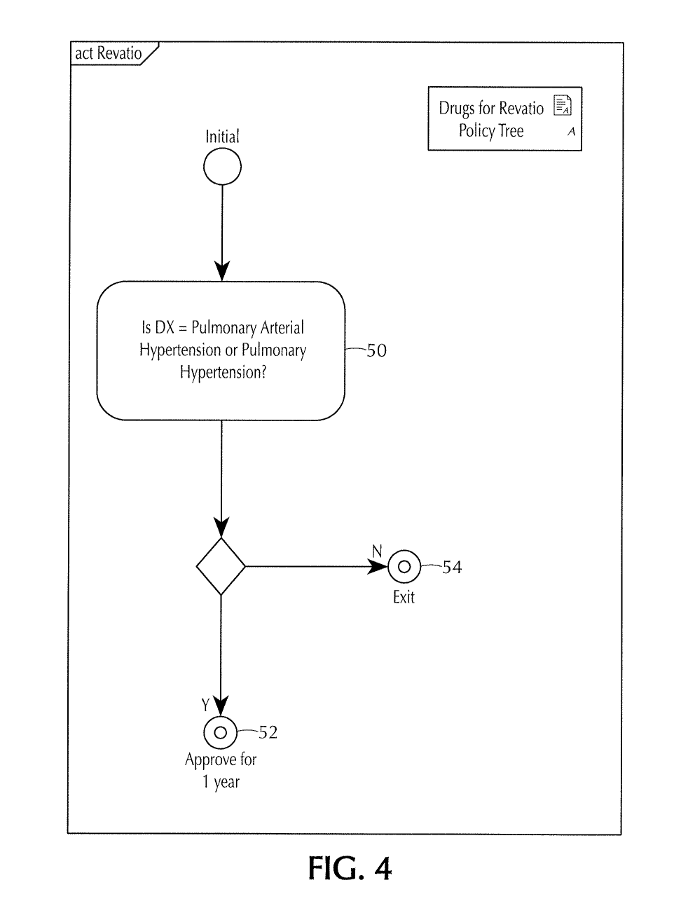

FIGS. 4, 5, and 6A-6C contain example processes for three decision trees, relating to the drugs Revatio and Adcirca, and the condition ED (erectile dysfunction), respectively. It is noted that the criteria listed in FIGS. 4-6 are merely example criteria, and therefore can be modified at any time. They could be removed, added to, or changed.

FIG. 4 shows an example processing (diagnosis only) according to the present invention for the drug Revatio, which is used to treat pulmonary arterial hypertension and improve exercise capacity in men and women. In step 50 it is determined whether the diagnosis (DX) is for Pulmonary Arterial Hypertension or Pulmonary Hypertension. If the answer is YES, then in step 52 the claim is paid with information already known to the health care management company. If the answer is NO, then in step 54 the claim is rejected.

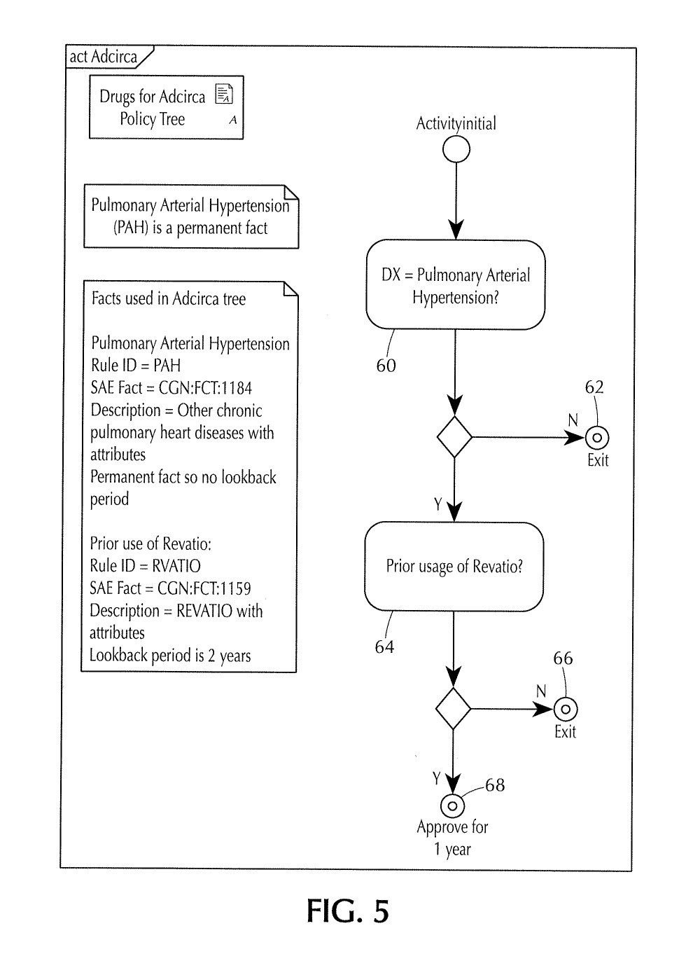

FIG. 5 shows an example processing (diagnosis and prior drug use check) according to the present invention for the drug Adcirca, which is used primarily to treat pulmonary arterial hypertension (PAH, or high blood pressure in the lungs) to improve one's ability to exercise. In step 60, it is determined whether the diagnosis (DX) is Pulmonary Arterial Hypertension. If no, then the claim is rejected in step 62. If yes, it is determined in step 64 whether there has been a prior usage of Revatio (within a prior predetermined time period, e.g., 2 years). If no, then the claim is rejected in step 66. If yes, then the claim is paid with information already known to the health care management company in step 68.

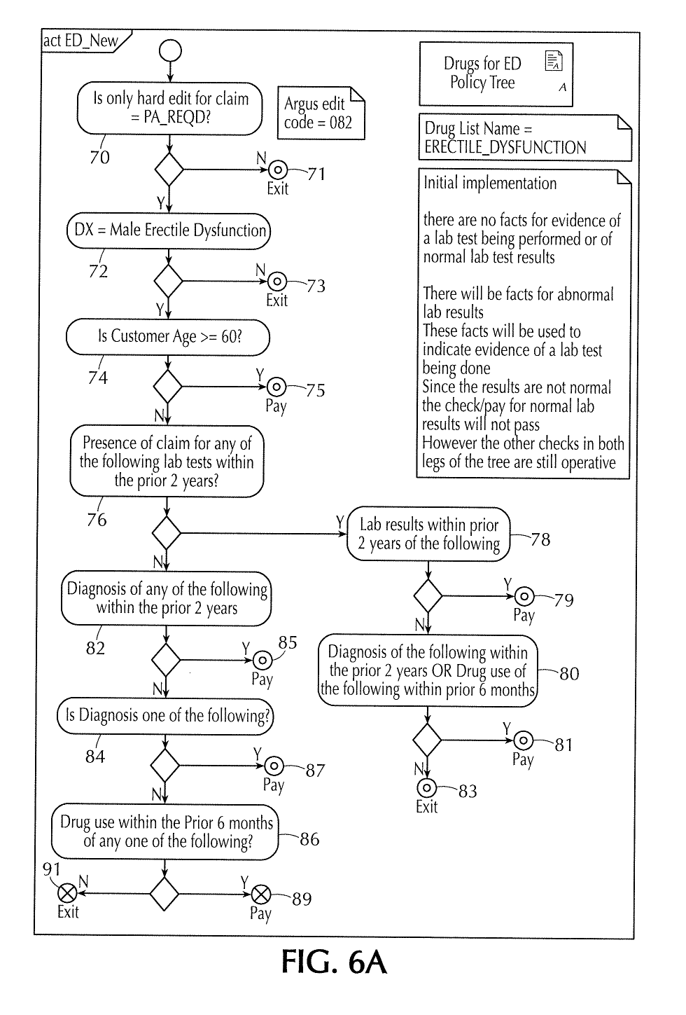

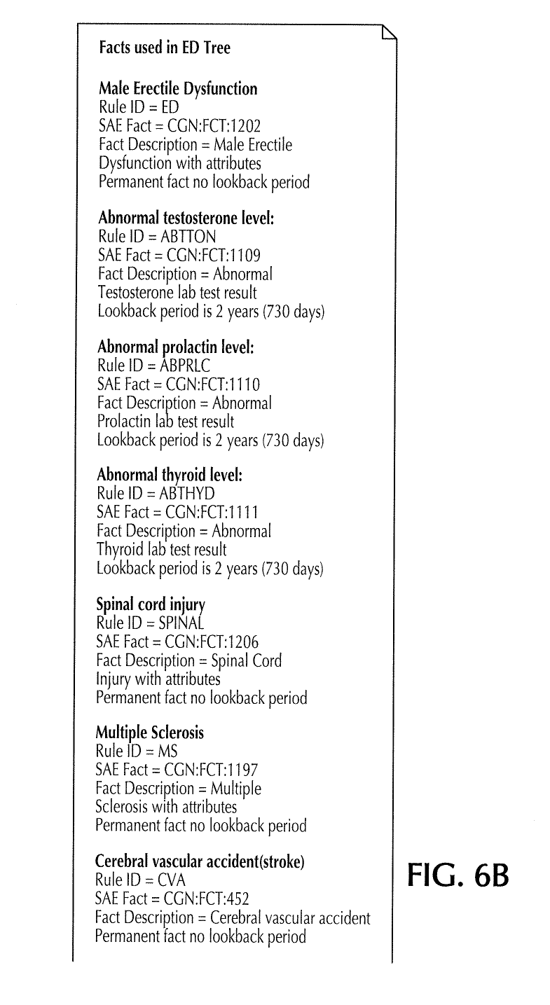

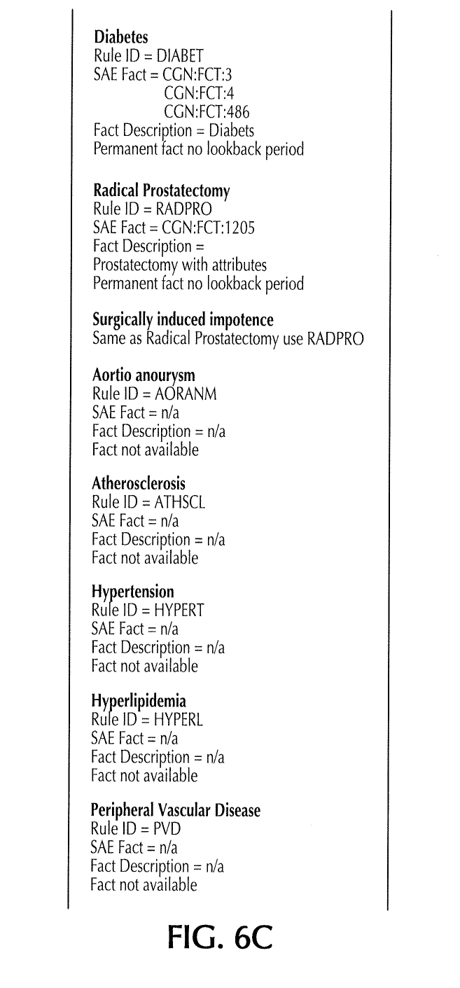

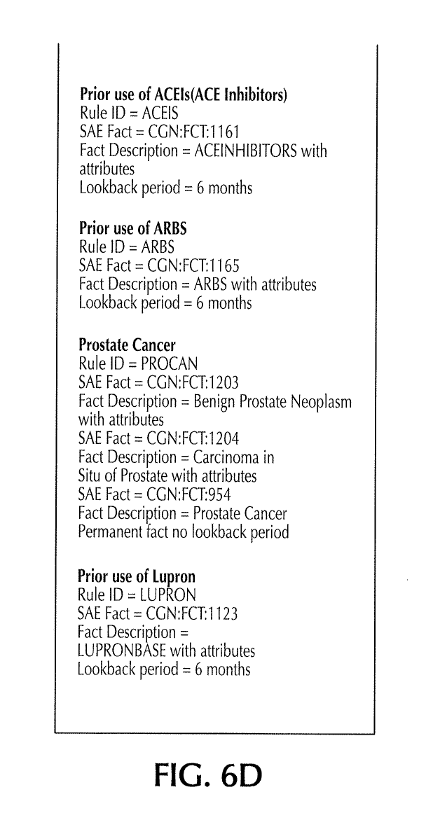

FIGS. 6A-6C show an example processing (a combination of diagnosis, prior use check, lab result check, and age) according to the present invention for the diagnosis (DX) of Male Erectile Dysfunction and a drug for treating such. FIG. 6A illustrates a flow of the processing, while FIGS. 6B and 6C show examples of facts used in the ED tree.

In step 70 it is checked whether there is only a hard edit for claim=PA_REQD. Only the PA REQD edit can be overridden by the ED tree. Any other hard errors—even those on the Autopay edit error list—should not be overridden by the ED tree and therefore in this case the claim is rejected in step 71. If the result of step 70 is YES then in step 72 it is checked whether there has been a diagnosis of ED. If not, then in step 73 the claim is rejected; if yes, then in step 74 it is determined whether the member age is at least 60 years old. If the member is at least 60, then the claim is processed in step 75.

In step 76 it is determined whether there has been the presence of a claim for any of the following lab tests within the prior 2 years: Testosterone; Prolactin; or Thyroid level. If not, the process proceeds to step 82. If so, then in step 78 it is determined whether there are lab results within the prior 2 years of the following: normal testosterone level; normal prolactin level; or normal thyroid level; if yes, then the claim is paid in step 79, while if not, the processing proceeds to step 80.

In step 80 it is determined whether there has been a diagnosis of the following within the prior 2 years OR drug use of the following within prior 6 months. Diagnoses within the prior 2 years: prostate cancer. (Other diagnoses may be identified at a later date.) Drug use within the prior 6 months: Lupron. (Other drugs may be identified at a later date.) If either of these have occurred, then the claim is paid in step 81, and if not then the claim is rejected in step 83.

In step 82 it is determined whether there has been a diagnosis of any of the following within the prior 2 years: spinal cord injury; multiple sclerosis; cerebral vascular accident (CVA); diabetes; radical prostatectomy; or surgically induced impotence. (Other diagnoses may be identified at a later date.) If yes then the claim is paid in step 85. If not then in step 84 it is determined whether there is a diagnosis of one of the following: aortic aneurysm; atherosclerosis; hypertension; hyperlipidemia; or peripheral vascular disease (PVD). (Other diagnoses may be identified at a later date.)

If yes in step 84, then the claim is paid in step 87. If no in step 84, then in step 86 it is determined whether there has been drug use within the prior 6 months of any one of the following: ACEIs; or ARBs. (Other drugs may be identified at a later date.) If yes, then the claim is paid in step 89, and if not the claim is rejected in step 91.

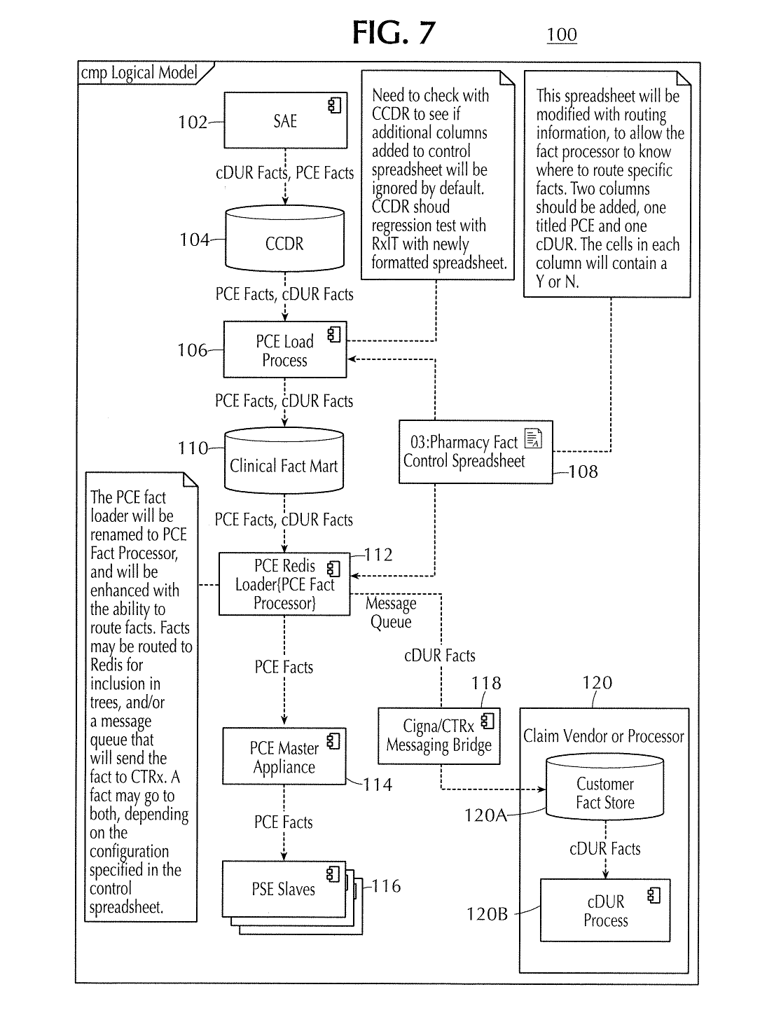

FIG. 7 illustrates a concurrent Drug Utilization Review (cDUR) process 100 according to another aspect of the present invention. There exist, for example, cases in which a doctor prescribes specific medication for a patient but the patient is on other current medication; in that situation it may not be ideal to take or prescribe the specific medication. In some processes according to the present invention as previously described herein, when a new claim comes in, the drug history of the patient is compared to see if the drug can be prescribed. The vendor is sent a diagnosis code reflecting a known diagnosis. With the cDUR process of the present invention, the vendor can use the patient's own claim history to infer a diagnosis and implement the drug.

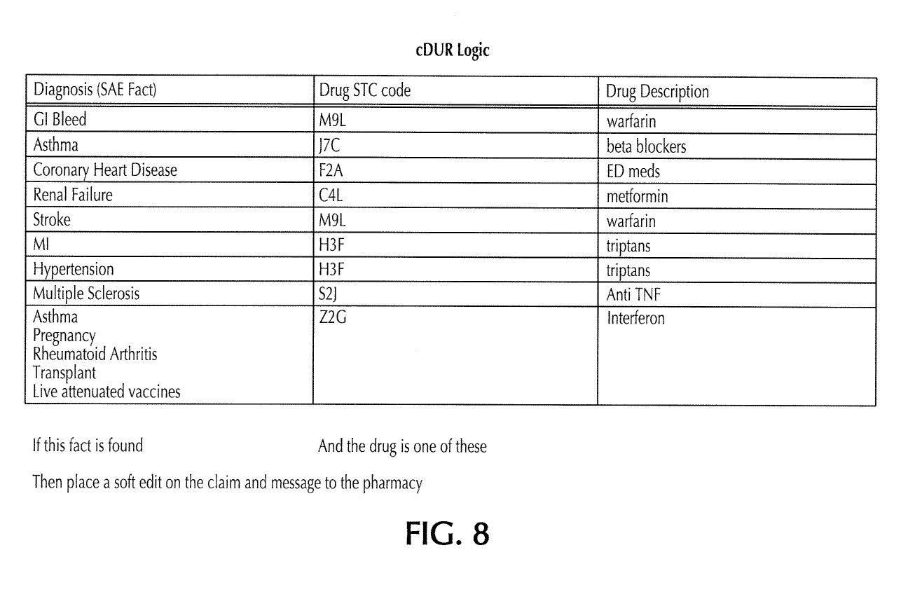

In more detail, in other embodiments of the present invention described herein which use factors such as age, gender, etc. (see, e.g., step 6 of FIG. 1), the facts of the customer are scanned and a decision is made thereon. With the cDUR process according to the aspects of the present invention shown in FIGS. 7 and 8, additional facts (not a diagnosis) are created that relate to the conditions. Facts are added in the pre-processor; that is, additional facts are sent to the vendor to incorporate into the decision making process. Additional pieces of data about each customer are created (e.g., by a Pharmacy Benefit Manager integrated into a medical payer) and sent to the vendor for processing. FIG. 8 shows current requirement for the cDUR logic of the present invention according to an example aspect of conditions and drug classes that cDUR will operate on. The present invention compares the STC (Standard Therapeutic Class) of the drug being purchased against a generated list of relevant customer facts. If an SAE fact from the “Diagnosis” column is found (e.g., renal failure or stroke), and the drug is one listed in the “Drug STC code” column, then a soft edit is placed on the claim and an appropriate message to the pharmacy is delivered to process or pay the claim.

Returning to FIG. 7, the SAE block 102 represents a structured analytic environment (SAE). The SAE block 102 scans through the medical history of a patient and creates a set of facts. There are cDUR facts (e.g., diabetes) and PCE facts, which are sent to the CCDR block 104 (Consumer Centric Data Repository). The CCDR block 104 acts as a staging area and moves the data into a better suited format for processing. The cDUR facts and the PCE facts are sent from the CCDR block 104 to the PCE Load Process block 106, which pushes the facts to the next stage. A pharmacy fact control spreadsheet 108, for example, can be modified with routing information to allow the fact processor to know where to route specific facts.

The PCE facts and cDUR facts are sent from the PCE Load Process 106 to the Clinical Fact Mart 110, which converts the facts into another format suitable for processing, and then the PCE facts and cDUR facts are sent to the PCE Redis Loader (PCE Fact Processor) 112. The PCE Redis Loader or PCE Fact Processor 112 is used to import data into service and format, and has the ability to route facts. PCE facts are sent from block 112 to the PCE Master Appliance 114, which can be created, controlled, and maintained by for example a Pharmacy Benefit Manager integrated into a medical payer. The PCE Master Appliance 114 consumes facts and contains all the logic that a slave has but doesn't use it; the PCE Master Appliance 114 keeps the slaves in sync, and pushes data to the PCE Slaves block 116. The Master Appliance 114 is a place (controlled or maintained, e.g., by a health care management company) where all the data/rules exist that can be pushed to the slaves. The cDUR process of the present invention can be implemented on any medical claims engine by adding slaves.

The Clinical Fact Mart 110 transmits cDUR facts through the messaging bridge 118 (via PCE Redis Loader 112), which contains software that is common to reliably receive and distribute messages, to the claim vendor or processor 120. The claim vendor or processor 120, which comprises customer fact store 120A and cDUR process block 120B, receives the facts and implements the cDUR processes. Conventionally, facts (e.g., pharmacy claims) were taken and decisions made. The present invention takes facts (pharmacy claims) plus additional facts (medical claims, e.g., doctors, procedures, etc.) and uses them to make decisions. This is one way in which the cDUR process of the present invention has an added advantage.

The present invention or any part(s) or function(s) thereof, including the system 30 of FIG. 3 and its components (e.g., the data integration module 32, the database 34, the rules module 36, the rules maintenance portal 38, the authorization module 40, and the claim engine 42), and including the components of FIG. 7, may be implemented using hardware, software, or a combination thereof, and may be implemented in one or more computer systems or other processing systems. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The computer system can include a display interface that forwards graphics, text, and other data from the communication infrastructure (or from a frame buffer) for display on a display unit. The display interface can communicate with a browser. The computer system also includes a main memory, preferably a random access memory, and may also include a secondary memory and a database. The secondary memory may include, for example, a hard disk drive and/or a removable storage drive, representing a floppy disk drive, a magnetic tape drive, an optical disk drive, etc. The removable storage drive reads from and/or writes to a removable storage unit in a well known manner. The removable storage unit can represent a floppy disk, magnetic tape, optical disk, etc. which is read by and written to by the removable storage drive. As will be appreciated, the removable storage unit can include a computer usable storage medium having stored therein computer software and/or data.

The computer system may also include a communications interface which allows software and data to be transferred between the computer system and external devices. The terms “computer program medium” and “computer usable medium” are used to refer generally to media such as the removable storage drive, a hard disk installed in the hard disk drive, and signals. These computer program products provide software to the computer system.

Computer programs or control logic are stored in the main memory and/or the secondary memory. Computer programs may also be received via the communications interface. Such computer programs or control logic (software), when executed, cause the computer system or its processor to perform the features and functions of the present invention, as discussed herein.

Software embodiments of the present invention may be provided as a computer program product, or software, that may include an article of manufacture on a machine accessible or machine readable medium (memory) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above-described exemplary embodiments, but should be defined only in accordance with the following claims and their equivalents.

In addition, it should be understood that the Figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

What is claimed is:

1. A method implemented on a computer having a processor and a memory coupled to said processor for determining whether to process a claim for a drug for a member, comprising the steps of:
receiving the claim for the drug subject to specific clinical edits;
accessing criteria specific to the drug;
evaluating the claim for the drug with regard to the criteria specific to the drug; and
determining based on one or more of the criteria whether to process the claim,
wherein at least one of the steps is performed using the processor, and wherein the criteria includes at least one of: a) sex of the member, b) age range of the member, c) a dosage range of the drug, d) existence of a prior claim within a predetermined time period with (i) one or more instances of another drug used in a given list, or (ii) one or more instances of a past diagnosis in a given list, or (iii) one or more instances of a past procedure in a given list, and e) existence of one or more lab results for a given condition.

2. The method of claim 1, wherein said determining step makes a determination to reject the claim if insufficient information exists to pay the claim.

3. The method of claim 1, further comprising the step of creating criteria specific to each drug in a set of drugs.

4. The method of claim 1, further comprising scanning or accessing medical data to construct a set of data for evaluating a claim based on the criteria specific to the drug.

5. The method of claim 4, wherein the medical data includes one or more of data relating to previous diagnoses, data specific to patients, data specific to drugs, data specific to physicians, data comprising previous pharmacy or medical claims, lab values from diagnostic vendors, and demographic data.

6. A non-transitory computer-readable medium storing a program, which, when executed by at least one processor, causes the at least one processor to perform the steps according to claim 1.

7. A method implemented on a computer having a processor and a memory coupled to said processor for creating a claim evaluation system for determining whether to process a claim for a drug for a member, comprising the steps of:
creating a set of rules criteria;
storing the set of rules criteria in a database;
accessing medical data to construct a set of data to be used in evaluating the claim; and
evaluating the claim based on the set of rules criteria to determine whether to process the claim.

8. The method of claim 7, wherein the medical data includes one or more of data relating to previous diagnoses, data specific to patients, data specific to drugs, data specific to physicians, data comprising previous pharmacy or medical claims, lab values from diagnostic vendors, and demographic data.

9. A non-transitory computer-readable medium storing a program, which, when executed by at least one processor, causes the at least one processor to perform the steps according to claim 9.

10. A method implemented on a computer having a processor and a memory coupled to said processor for determining whether to process a claim for a drug for a member, comprising the steps of:
receiving the claim for the drug;
evaluating whether the claim meets predetermined clinical edits;
if the claim meets the predetermined clinical edits, processing the claim;
if the claim does not meet the predetermined clinical edits, evaluating whether the claim meets a set of criteria including at least one of certain drugs, certain physicians, and certain associated edits of drugs;
if the claim meets said set of criteria, processing the claim;
if the claim does not meet said set of criteria, processing the claim if a pre-authorization exists or if the drug is available for AutoPay, otherwise denying the claim,
wherein at least some of the steps are performed by the processor.

11. A non-transitory computer-readable medium storing a program, which, when executed by at least one processor, causes the at least one processor to perform the steps according to claim 10.

12. A method implemented on a computer having a processor and a memory coupled to said processor for determining whether to process a claim for a drug for a customer, comprising the steps of:
receiving, by a claim engine, a claim for a drug for a customer;
evaluating, by the claim engine, the claim for the drug and obtaining an initial decision whether to pay the claim;
if the initial decision is to pay the claim, authorizing payment of the claim;
if the initial decision is to deny the claim due to an edit code on a drug edit list:
calling an authorization service module;
reading, by the authorization service module, the claim and sending the claim to a rules engine;
searching by the rules engine whether there are customer facts in a customer facts database and if so then loading by a rules module a set of rules and sending the customer conditions as well as point of sale variables to be evaluated by the rules;
receiving an answer, based on the rules evaluation, as to whether an authorization waiver override should be issued;
sending the answer to the authorization service module;
encoding by the authorization service module the answer and sending the answer back to the claim engine;
checking, by the claim engine, for the existence of the authorization waiver override inside the answer;
if the authorization waiver override was issued, allowing, by the claim engine, the claim to pay.

13. A system for determining whether to process a claim for a drug for a member, comprising:
a data integration unit, adapted to receive the claim for the drug subject to specific clinical edits;
a rules unit, adapted to access criteria specific to the drug and evaluate the claim for the drug with regard to the criteria specific to the drug; and
an authorization unit, adapted to determine based on one or more of the criteria whether to process the claim.

14. The system of claim 13, wherein the criteria includes at least one of: a) sex of the member, b) age range of the member, c) a dosage range of the drug, d) existence of a prior claim within a predetermined time period with (i) one or more instances of another drug used in a given list, or (ii) one or more instances of a past diagnosis in a given list, or (iii) one or more instances of a past procedure in a given list, and e) existence of one or more lab results for a given condition.

15. The system of claim 13, wherein the criteria includes at least one of certain drugs, certain physicians, and certain associated edits of drugs.

16. A system for determining whether to process a claim for a drug for a member, comprising:
a data integration unit, adapted to receive the claim for the drug;
a rules unit, adapted to evaluate whether the claim meets predetermined clinical edits, and if the claim does not meet the predetermined clinical edits, evaluate whether the claim meets a set of criteria including at least one of certain drugs, certain physicians, and certain associated edits of drugs; and
an authorization unit, adapted to authorize processing of the claim if the claim meets the predetermined clinical edits or if the claim meets the set of criteria; and if the claim does not meet said set of criteria, authorize processing of the claim if a pre-authorization exists or if the drug is available for AutoPay, otherwise deny the claim.

17. The system of claim 16, wherein the rules unit is further adapted to access a database containing a plurality of lists, wherein the lists include a drug list, a prescriber list, an edits list, a physicians list, and a list containing the set of criteria.

18. The method of claim 1, further comprising using additional criteria in the evaluating step to evaluate the claim for the drug, wherein the additional criteria comprises medical claims facts including at least one of doctors, procedures, and a comparison of the drug against a generated list of member facts.

19. The method of claim 7, wherein the set of rules criteria includes pharmacy claims facts and the creating step further comprises creating additional criteria for each member and using the additional criteria in the evaluating step to evaluate the claim for the drug, wherein the additional criteria comprises medical claims facts including at least one of doctors, procedures, and a comparison of the drug against a generated list of member facts.

20. The method of claim 12, wherein the rules set by the rules engine are created, maintained, and edited by a rules element portal.
